(19) United States
(12) Patent Application Publication
(10) Pub. No.: US 2024/0428630 A1
(43) Pub. Date: Dec. 26, 2024

(54) IDENTIFYING POSITION AND DETERMINING INTENT BASED ON UWB TEMPORAL SIGNATURES

(71) Applicant: ASSA ABLOY AB, Stockholm (SE)

(72) Inventors: Robert Kjell Rowe, Poulsbo, WA (US); Jing Ming, Abington, PA (US)

(21) Appl. No.: 18/698,087

(22) PCT Filed: Oct. 25, 2021
(86) PCT No.: PCT/US2021/072013

§ 371 Date: Apr. 3, 2024

(51) Int. Cl. G07C 9/00

(52) U.S. Cl. CPC G07C 9/00309; G07C 2009/00388; G07C 2009/00555

(57) ABSTRACT

Methods and program code for determining the position and/or intent of a user (or device) holding, carrying, wearing, or mounted with a UWB-enabled device. Example computer readable medium for determining the position and/or intent of a user comprises program code that when executed by one or more processors, causes the one or more processors to determine a current temporal signature for a first device moving within an environment; compare the current temporal signature with at least a portion of a stored reference temporal signature corresponding to a secure asset within the environment; and base an access control decision corresponding to the secure asset on whether it is determined that the current temporal signature corresponds to the at least a portion of the stored reference temporal signature.

### TECHNICAL FIELD

Embodiments described herein generally relate to identifying the position of a user and sensing or determining the user's intent (e.g., to access a secure asset) based on ultra-wideband (UWB) communication with a device held or carried by the person, and particularly based on UWB temporal signatures.

### BACKGROUND

UWB position sensing technology has recently started to be incorporated into various models of mobile devices, such as smartphone devices, mobile tablet devices, and other mobile systems. UWB technologies are generally capable of providing more accurate estimates of position as compared to alternative technologies, such as Bluetooth (e.g., BLE) or WiFi. The greater accuracy of UWB enables more and different use cases. As one example, when UWB position sensing is built into an access control reader of an access control system (ACS), such as a physical access control system (PACS), as well as built into a user's mobile device, such as the user's smartphone, then UWB position estimates of the user's mobile device can generally be used to make appropriate decisions regarding whether the user is permitted to access a secure asset, secured by the access control reader, based on the user's position and/or determined intent to access the secure asset. For example, where the access control reader controls access to a door or other entryway, UWB position estimates can generally be used to make appropriate decisions regarding whether to lock (or keep locked) or unlock the door/entryway based on the user's position and/or determined intent to pass through the door/entryway. In such an example, a particularly important aspect of the position estimate is determining whether the user is on an outside or unsecure side of the door/entryway or on an inside or secure side of the door/entryway. The distinction is important because the behavior of the PACS might be very different based on whether the user is on the unsecure side of the door/entryway as opposed to the secure side of the door/entryway, even if the user is the same distance away from the door/entryway in both cases. For example, if an authorized user approaches the controlled door/entryway from the outside/unsecure side of the door/entryway, the PACS should unlock the door/entryway if it the user's credential(s) is/are authenticated. Conversely, if the same authorized user is on the inside/secure side of the door/entryway and near the door/entryway, the PACS might not automatically unlock the door/entryway since the user might be approaching the door/entryway for reasons other than his/her own access, such as merely walking past the door/entryway on his/her way to another destination, approaching the door/entryway in order to determine the identity of an unknown person on the outside/unsecure side of the door/entryway, etc.

UWB position sensing in a UWB system is generally performed in two different steps. One step involves determining an estimate of the radial distance (D) between a UWB transmitter (or transceiver) and a UWB receiver (or transceiver). This distance estimate is generally determined as a time-of-flight measurement operating on the ultra-short, UWB pulses. The resulting estimate is generally fairly accurate and robust to the radio frequency (RF) environment in which the UWB system exists. A second step involves determining an estimate of the angle of arrival (AoA) of the UWB transmitter, which describes the angular orientation of the UWB transmitter relative to the UWB receiver. A common approach for determining UWB AoA measurements is to incorporate two or more antennas in the UWB receiver separated by some distance and orientation. In this way, a received UWB signal is sensed by each of the antennas, and the phase relationship between the sensed UWB signals is used to estimate the AoA. One such pair of antennas can be used to estimate radial distance and AoA in a 2-dimensional (2D) plane, with a 180-degree ambiguity around the line of symmetry of the antenna pair. If necessary or desired, multiple pairs of antennas and/or an antenna array can be used to locate a UWB transmitter (e.g., estimate radial distance and AoA) in a three-dimensional (3D) space.

The foregoing method works well in ideal, “line-of-sight” (LOS) environments, but is very susceptible to RF reflections and other multipath effects in a non-line-of-sight (NLoS) environment. In NLOS environments, which are quite common, the AoA estimates are often extremely noisy, distorted, and/or inaccurate, which in turn compromises the ability to determine an accurate position of the UWB transmitter. In some cases, multiple AoA measurements may be acquired and aggregated in some way (e.g., averaged), which might reduce the AoA errors. In one common arrangement, UWB antennas are arranged such that measurements from opposite sides of secure asset (e.g., door/entryway) nominally provide AoA estimates with opposite signs (e.g., if the UWB antennas are positioned on an outside of the secure asset, then inside corresponds to angles 0 degrees to −90 degrees and outside corresponds to angles 0 degrees to +90 degrees). In such cases, the signs of the AoA measurements may be summed over a set of measurements, and the inside/outside determination is derived from the sign of the total sum. Generally, however, the result of such methods is still significantly error prone.

In addition to accurate position determination, it is also useful for the UWB system to estimate and properly respond to user intent (e.g., intent to access the secure asset). In the case of an access control system, a user may be in close proximity to the controlled door/entryway but not actually have intent to pass through. For example, the user may approach the door/entryway and pause before deciding to passing through or turn-around and decide not to pass through. As another example, the user may be seated or otherwise stationary for extended periods of time within the sensing range of the access control reader due to the configuration of the room and the furniture within. In both of these examples, and in other scenarios, it would be desirable for the access control system to determine that the user is not demonstrating intent to pass through the door/entryway and, therefore, determine not to unlock the door/entryway. Known methods of pointwise accumulation used to estimate AoA, as described above, do not generally alone provide a good measure of user intent.

For at least these reasons, there is a need in the art for improved methods and systems for determining the position and/or intent of a user (or device) holding, carrying, wearing, or mounted with a UWB-enabled device.

### BRIEF SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a non-transitory computer readable medium comprising executable program code, that when executed by one or more processors, causes the one or more processors to monitor ultra-wideband (UWB) signals between a first device and second device, wherein the first device is in a fixed location and the second device is portable; determine a reference temporal signature associated with the first device based on the UWB signals; and store the reference temporal signature in the computer readable medium; wherein the reference temporal signature is indicative of intent to access a secure asset associated with the first device.

The present disclosure, in one or more embodiments, additionally relates to a non-transitory computer readable medium comprising executable program code, that when executed by one or more processors, causes the one or more processors to determine a current temporal signature for a first device moving within an environment; compare the current temporal signature with at least a portion of a stored reference temporal signature corresponding to a secure asset within the environment; and base an access control decision corresponding to the secure asset on whether it is determined that the current temporal signature corresponds to the at least a portion of the stored reference temporal signature.

The present disclosure, in one or more embodiments, additionally relates to a method for calibrating an environment. The method comprises monitoring ultra-wideband (UWB) signals between a first device and second device, wherein the first device is in a fixed location and the second device is portable; determining a reference temporal signature associated with the first device based on the UWB signals; and storing the reference temporal signature in a computer readable storage medium; wherein the reference temporal signature is indicative of intent to access a secure asset associated with the first device.

The present disclosure, in one or more embodiments, additionally relates to a method for determining a location of a device within an environment. The method comprises determining a current temporal signature for a first device moving within the environment; comparing the current temporal signature with at least a portion of a stored reference temporal signature corresponding to a secure asset within the environment; and basing an access control decision corresponding to the secure asset on whether it is determined that the current temporal signature corresponds to the at least a portion of the stored reference temporal signature.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the scope of the present disclosure. Accordingly, the drawings and detailed description are to be regarded as illustrative in nature and not restrictive.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates a front view of an example environment, in the form of an access control system (ACS), or portions thereof, for determining the position and/or intent of a user holding, carrying, wearing, or mounted with a UWB-enabled device, as described herein;

FIG. 2 illustrates a top cross-sectional view of an example environment, in the form of an ACS, or portions thereof;

FIG. 3 illustrates a block diagram schematic of various components of an example reader device;

FIG. 4 illustrates a block diagram schematic of various example components of an example machine that may be used as, for example, a control panel, host server, a credential device, and/or a UWB-enabled device of the present disclosure;

FIG. 5 illustrates a larger view of an example environment for determining the position and/or intent of a user holding, carrying, wearing, or mounted with a UWB-enabled device, as described herein;

FIG. 6 is a flow chart generally illustrating an example method(s) for calibrating an environment, such as the example environment of FIGS. 1 and 5; and

FIG. 7 is a flow chart generally illustrating an example method for determining the position and/or intent of a user holding, carrying, wearing, or mounted with a UWB-enabled device, as described herein.

### DETAILED DESCRIPTION

The present disclosure generally relates to improved methods and systems for determining the position and/or intent of a user (or device) holding, carrying, wearing, or mounted with a UWB-enabled device. At a very general level, embodiments of the present disclosure enable estimating user or device position and/or intent by gathering and analyzing a temporal “signature” while the user (and more particularly, the UWB-enabled device held, carried, or worn by the user or mounted on the device) is in UWB reading range of one or more other UWB sensors (e.g., transmitters, receivers, transceivers). Such a temporal signature generally comprises a sequence of measurements combining two or more types of UWB signals. A determination or estimate of user position relative a secure asset (e.g., door/entryway), such as whether the user is on a secure side (e.g., inside) or unsecure side (e.g., outside) of a door/entryway, can be performed by comparing a current temporal signature for the user to one or more previously determined reference temporal “signatures,” such as but not limited to, one or more reference temporal signatures acquired in-situ sometime following installation of a UWB-enabled access control reader within a particular environment. In this way, each reference temporal signature represents unique characteristics of the RF environment in which the UWB measurements are made, thereby ameliorating the need for AoA estimates and/or other UWB measurements to respond in an ideal manner. While the term “user” is used throughout the present disclosure to represent a person holding, carrying, wearing, or mounted with a UWB-enabled device, other embodiments of the present disclosure include methods and systems for determining the position and/or intent of a device, such as machinery, equipment, automobile, construction device/material, appliance, electronic device, robot, etc., which has the UWB-enabled device mounted or attached thereto or associated therewith. Accordingly, use of the term “user” in the present disclosure is intended to include both human users and devices (i.e., device “users”).

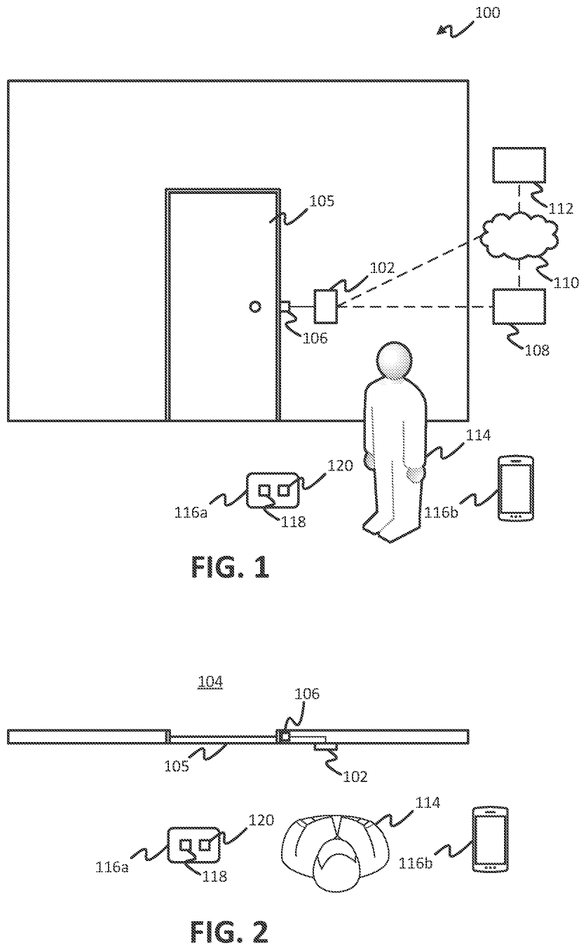

FIGS. 1 and 2 illustrate an example environment 100 for determining the position and/or intent of a user holding, carrying, wearing, or mounted with a UWB-enabled device. In the example of FIGS. 1 and 2, environment 100 is an access control system (ACS), or portions thereof. While FIGS. 1 and 2 primarily illustrate a PACS, it is recognized that the present disclosure similarly relates to a logical access control system (LACS) or any other environment in which it is desired to determine position and/or intent of a user. Environment 100 can include a reader device, or simply reader, 102 associated with a secure area, access point, or other asset 104. In some cases, such as in the example illustrated in FIGS. 1 and 2, secure asset 104 is a secure area secured by an access point 105, such as a door, gate, turnstile or the like controlling or permitting authorized access to the secure area, but secure asset 104 may alternatively be a logical asset. Reader 102 can include or be operably connected with a control mechanism 106, such as but not limited to a locking mechanism in the case of PACS or an electronic/software control mechanism in the case of LACS, that controls whether access via access point 106 is permitted (e.g., can be opened or accessed) or may even control opening and/or closing of the access point. Reader 102 can be an offline reader, e.g., a reader not connected to a control panel or host server, and in such cases may make its own access control determinations and directly operate or command control mechanism 106, accordingly. Reader 102 can be a wireless reader device, in that the reader may communicate with credential or key devices via wireless technologies, such as RFID or PAN technologies, such as the IEEE 802.15.1, Bluetooth, Bluetooth Low Energy (BLE), near field communications (NFC), ZigBee, GSM, CDMA, Wi-Fi, UWB, etc. Reader 102 may also include a PIN pad, touch screen, fingerprint reader, magnetic stripe reader, chip reader, or other non-wireless input means for receiving credential or other information, such as a PIN or other secret code, biometric information such as a fingerprint, or information from a magnetic stripe card or chip card, for example. Reader 102 may also include facial recognition capabilities.

In some cases, reader 102 can be connected by wire or wirelessly to a control panel 108. In such cases, reader 102 may transmit credential information to control panel 108, and the control panel may make, or may share responsibilities with the reader in making, access control determinations. Based on the access control determinations, control panel 108 can instruct reader 102 to operate or command control mechanism 106, accordingly. Alternately, control panel 108 can be connected directly or wirelessly to control mechanism 106, and in such cases may directly operate or command the control mechanism, accordingly, bypassing reader 102.

In some cases, reader 102 and control panel 108, and even control mechanism 106, can be connected to a wired or wireless network 110 and communicate with each other, as described above, via the network. Example networks can include a local area network (LAN), a wide area network (WAN), a packet data network (e.g., the Internet), mobile telephone networks (e.g., cellular networks), Plain Old Telephone (POTS) networks, wireless data networks (e.g., networks based on the IEEE 802.11 family of standards known as Wi-Fi or the IEEE 802.16 family of standards known as WiMax), networks based on the IEEE 802.15.4 family of standards, and peer-to-peer (P2P) networks, among others. If environment 100 is managed by a remote system, the environment can include a host server 112 connected by wire or wirelessly to network 110 and that may communicate with reader 102 and/or control panel 108. In such cases, reader 102 can transmit credential information to host server 112 via network 110 or can transmit credential information to control panel 108, which can then transmit the credential information to the host server via the network. Host server 112 may make, or may share responsibilities with reader 102 and/or control panel 108 in making, access control determinations. Based on the access control determinations, host server 112 can instruct reader 102, directly or indirectly via control panel 108, to operate or command control mechanism 106, accordingly. Alternately, host server 112 can instruct control panel 108 to operate or command control mechanism 106, accordingly. In still another example, host server 112 can be connected via network 110 to control mechanism 106 and directly operate or command the control mechanism, accordingly, bypassing reader 102 and control panel 108.

In use, a user 114 having a credential or key device 116 (illustrated, for example, as a smartcard 116a or mobile device 116b) approaches reader 102 associated with access point 105. The credential device 116 may communicate the user's credential or credential data to the reader 102, for example, via a suitable RFID or PAN technology. In general, a credential device 116 may include any device that carries evidence of authority, status, rights, and/or entitlement to privileges for a holder of the credential device. A credential device 116 can be a portable device having memory 118, storing one or more user credentials or credential data, and a reader interface (i.e., an antenna and Integrated Circuit (IC) chip) 120, which permits the credential to exchange data with a reader device, such as reader 102, via a credential interface of the reader device, such as an antenna. One example of credential device 116 is an RFID smartcard (e.g., smartcard 116a) that has data stored thereon allowing a holder of the credential device to access a secure area or asset protected by reader 102, such as secure area 104. Other examples of credential devices 116 include, but are not limited to, proximity RFID-based cards, access control cards, credit cards, debit cards, passports, identification cards, key fobs, NFC-enabled devices, mobile phones (e.g., mobile device 116b), personal digital assistants (PDAs), tags, or any device configurable to emulate a virtual credential. If reader 102, control panel 108, and/or host server 112 determine that the user's 114 credential or credential data provided by credential device 116 is valid and/or authorized, reader 102, control panel 108, or host server 112 may operate control mechanism 106 to allow access to the secure asset 104 by the user 114 having the credential device.

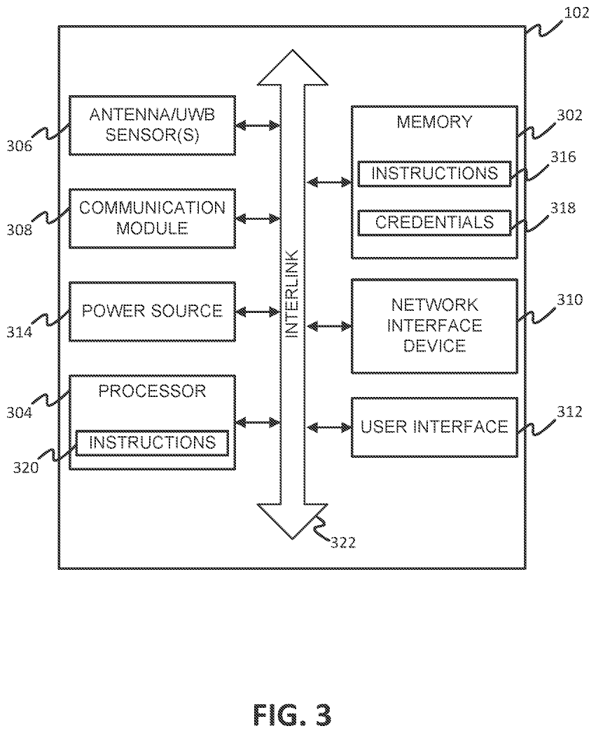

FIG. 3 illustrates a block diagram schematic of various components of an example reader 102. In general, reader 102 can include one or more of a memory 302, a processor 304, one or more antennas 306, a communication module 308, a network interface device 310, a user interface 312, and a power source or supply 314. While reader 102 is illustrated in FIG. 1 as a device affixed to a surface, for example a wall, reader 102 may also be a free-standing device or a portable device, such as but not limited to a mobile device.

Memory 302 can be used in connection with the execution of application programming or instructions by processor 304, and for the temporary or long-term storage of program instructions or instruction sets 316 and/or credential or authorization data 318, such as credential data, credential authorization data, access control data or instructions, or instructions for determining the position and/or intent of a user holding, carrying, wearing, or mounted with a UWB-enabled device, as described herein. For example, memory 302 can contain executable instructions 316 that are used by the processor 304 to run other components of reader 102 and/or to determine the position and/or intent of a user, as described herein, and make access determinations based on credential or authorization data 318. Memory 302 can comprise a computer readable medium that can be any medium that can contain, store, communicate, or transport data, program code, or instructions for use by or in connection with reader 102. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or EEPROM), Dynamic RAM (DRAM), any solid-state storage device, in general, a compact disc read-only memory (CD-ROM), or other optical or magnetic storage device. Computer readable media includes, but is not to be confused with, computer readable storage medium, which is intended to cover all physical, non-transitory, or similar embodiments of computer readable media.

Processor 304 can correspond to one or more computer processing devices or resources. For instance, processor 304 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 304 can be provided as a microprocessor, Central Processing Unit (CPU), or plurality of microprocessors or CPUs that are configured to execute instructions sets stored in an internal memory 320 and/or memory 302.

Antenna 306 can correspond to one or multiple antennas and can be configured to provide for wireless communications between, for example, reader 102 and a credential or key device or other device. Antenna(s) 306 can be arranged to operate using one or more wireless communication protocols and operating frequencies including, but not limited to, the IEEE 802.15.1, Bluetooth, Bluetooth Low Energy (BLE), near field communications (NFC), ZigBee, GSM, CDMA, Wi-Fi, RF, UWB, and the like. By way of example, antenna(s) 306 can be RF antenna(s), and as such, may transmit/receive RF signals through free-space to be received/transferred by a credential or key device having an RF transceiver. In examples of the present disclosure, which generally relate to improved methods and systems for determining the position and/or intent of a user (or device) holding, carrying, wearing, or mounted with a UWB-enabled device, antenna 306 may at least include one or more UWB sensors, such as one or more UWB transmitters, receivers, or transceivers, one or more UWB antenna pairs, and/or a UWB antenna array.

Communication module 308 can be configured to communicate according to any suitable communications protocol with one or more different systems or devices either remote or local to reader 102, such as one or more control mechanisms 106 or control panel 108.

Network interface device 310 includes hardware to facilitate communications with other devices, such as control panel 108 or host server 112, over a communication network, such as network 110, utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., networks based on the IEEE 802.11 family of standards known as Wi-Fi or the IEEE 802.16 family of standards known as WiMax), networks based on the IEEE 802.15.4 family of standards, and peer-to-peer (P2P) networks, among others. In some examples, network interface device 310 can include an Ethernet port or other physical jack, a Wi-Fi card, a Network Interface Card (NIC), a cellular interface (e.g., antenna, filters, and associated circuitry), or the like. In some examples, network interface device 310 can include one or more antennas to wirelessly communicate using, for example, at least one of single-input multiple-output (SIMO), multiple-input multiple-output (MIMO), or multiple-input single-output (MISO) techniques.

User interface 312 can include one or more input devices and/or display devices. Examples of suitable user input devices that can be included in user interface 312 include, without limitation, one or more buttons, a keyboard, a mouse, a touch-sensitive surface, a stylus, a camera, a microphone, a PIN pad, touch screen, fingerprint reader, magnetic stripe reader, chip reader, etc. Examples of suitable user output devices that can be included in user interface 312 include, without limitation, one or more LEDs, a LCD panel, a display screen, a touchscreen, one or more lights, a speaker, etc. It should be appreciated that user interface 312 can also include a combined user input and user output device, such as a touch-sensitive display or the like.

Power source 314 can be any suitable internal power source, such as a battery, capacitive power source or similar type of charge-storage device, etc., and/or can include one or more power conversion circuits suitable to convert external power into suitable power (e.g., conversion of externally-supplied AC power into DC power) for components of the reader 102. Power source 314 can also include some implementation of surge protection circuitry to protect the components of reader 102 from power surges.

Reader 102 can also include one or more interlinks or buses 322 operable to transmit communications between the various hardware components of the reader. A system bus 322 can be any of several types of commercially available bus structures or bus architectures.

Although various example components of a reader 102 are described and illustrated, not all components are required in each reader described herein and no reader described herein is limited to including just the example components described and illustrated herein. For example, any of the readers 102 described herein may comprise a different set and/or combination of the example components described and illustrated herein.

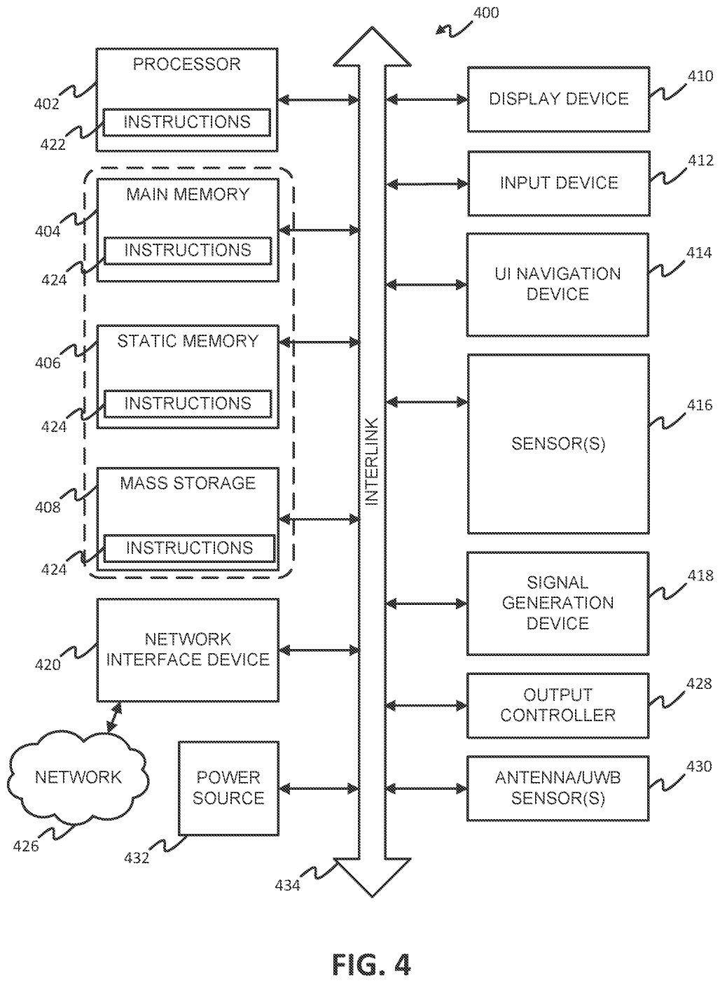

FIG. 4 illustrates a block diagram schematic of various example components of an example machine 400 that can be used as, for example, control panel 108, host server 112, credential device 116, and/or a UWB-enabled device according to the present disclosure. Examples, as described herein, can generally include, or can operate by, logic or a number of components, modules, or mechanisms in machine 400. Modules may be hardware, software, or firmware communicatively coupled to one or more processors in order to carry out the operations described herein. Generally, circuitry (e.g., processing circuitry) of example machine 400 may include a collection of circuits implemented in tangible entities of the machine 400 that include hardware (e.g., simple circuits, gates, logic, etc.). Circuitry membership can be flexible over time. Circuitries include members that can, alone or in combination, perform specified operations when operating. In some examples, hardware of the circuitry can be immutably designed to carry out a specific operation (e.g., hardwired). In some examples, the hardware of the circuitry can include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions permit embedded hardware (e.g., the execution units or a loading mechanism) to create members of the circuitry in hardware via the variable connections to carry out portions of the specific operation when in operation. Accordingly, in some examples, the machine readable medium elements are part of the circuitry or are communicatively coupled to the other components of the circuitry when the device is operating. In some examples, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional and/or more specific examples of components with respect to machine 400 follow.

In some embodiments, machine 400 can operate as a standalone device or can be connected (e.g., networked) to other machines. In a networked deployment, machine 400 can operate in the capacity of a server machine, a client machine, or both in server-client network environments. In some examples, machine 400 can act as a peer machine in a peer-to-peer (P2P) (or other distributed) network environment. Machine 400 can be or include a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 400 can include a hardware processor 402 (e.g., a central processing unit (CPU), a graphics processing unit (GPU), a hardware processor core, or any combination thereof) and a main memory 404, a static memory (e.g., memory or storage for firmware, microcode, a basic-input-output (BIOS), unified extensible firmware interface (UEFI), etc.) 406, and/or mass storage 408 (e.g., hard drives, tape drives, flash storage, or other block devices) some or all of which can communicate with each other via an interlink (e.g., bus) 434. Machine 400 can further include a display device 410, an input device 412, and/or a user interface (UI) navigation device 414. Examples of suitable display devices include, without limitation, one or more LEDs, a LCD panel, a display screen, a touchscreen, one or more lights, etc. Example input devices and UI navigation devices include, without limitation, one or more buttons, a keyboard, a touch-sensitive surface, a stylus, a camera, a microphone, etc. In some examples, one or more of the display device 410, input device 412, and/or UI navigation device 414 can be a combined unit, such as a touch screen display. Machine 400 can additionally include a signal generation device 418 (e.g., a speaker), a network interface device 420, one or more antennas 430, a power source 432, and one or more sensors 416, such as a global positioning system (GPS) sensor, compass, accelerometer, or other sensor. Machine 400 can include an output controller 428, such as a serial (e.g., universal serial bus (USB)), parallel, or other wired or wireless (e.g., infrared (IR), NFC, etc.) connection to communicate with or control one or more peripheral devices (e.g., a printer, card reader, etc.).

Processor 402 can correspond to one or more computer processing devices or resources. For instance, processor 402 can be provided as silicon, as a Field Programmable Gate Array (FPGA), an Application-Specific Integrated Circuit (ASIC), any other type of Integrated Circuit (IC) chip, a collection of IC chips, or the like. As a more specific example, processor 402 can be provided as a microprocessor, Central Processing Unit (CPU), or plurality of microprocessors or CPUs that are configured to execute instructions sets stored in an internal memory 422 and/or memory 404, 406, 408.

Any of memory 404, 406, and 408 can be used in connection with the execution of application programming or instructions by processor 402 for performing any of the functionality or methods described herein, and for the temporary or long-term storage of program instructions or instruction sets 424 and/or other data for performing any of the functionality or methods described herein, such as for determining the position and/or intent of a user holding, carrying, wearing, or mounted with a UWB-enabled device as described herein. Any of memory 404, 406, 408 can comprise a computer readable medium that can be any medium that can contain, store, communicate, or transport data, program code, or instructions 424 for use by or in connection with machine 400. The computer readable medium can be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or EEPROM), Dynamic RAM (DRAM), a solid-state storage device, in general, a compact disc read-only memory (CD-ROM), or other optical or magnetic storage device. As noted above, computer readable media includes, but is not to be confused with, computer readable storage medium, which is intended to cover all physical, non-transitory, or similar embodiments of computer readable media.

Network interface device 420 includes hardware to facilitate communications with other devices over a communication network 426, such as but not limited to, network 110, utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, wireless data networks (e.g., networks based on the IEEE 802.11 family of standards known as Wi-Fi or the IEEE 802.16 family of standards known as WiMax), networks based on the IEEE 802.15.4 family of standards, and peer-to-peer (P2P) networks, among others. In some examples, network interface device 420 can include an Ethernet port or other physical jack, a Wi-Fi card, a Network Interface Card (NIC), a cellular interface (e.g., antenna, filters, and associated circuitry), or the like. In some examples, network interface device 420 can include one or more antennas to wirelessly communicate using, for example, at least one of single-input multiple-output (SIMO), multiple-input multiple-output (MIMO), or multiple-input single-output (MISO) techniques.

Antenna 430 can correspond to one or multiple antennas and can be configured to provide for wireless communications between machine 400 and another device. Antenna(s) 430 can be arranged to operate using one or more wireless communication protocols and operating frequencies including, but not limited to, the IEEE 802.15.1, Bluetooth, Bluetooth Low Energy (BLE), near field communications (NFC), ZigBee, GSM, CDMA, Wi-Fi, RF, UWB, and the like. By way of example, antenna(s) 430 can be RF antenna(s), and as such, may transmit/receive RF signals through free-space to be received/transferred by another device having an RF transceiver. In examples of the present disclosure, which generally relate to improved methods and systems for determining the position and/or intent of a user (or device) holding, carrying, wearing, or mounted with a UWB-enabled device, antenna 430 of some machines 400, such as the credential device 116 or a UWB-enabled device pursuant to the present disclosure, may at least include one or more UWB sensors, such as one or more UWB transmitters, receivers, or transceivers, one or more UWB antenna pairs, and/or a UWB antenna array.

Power source 432 can be any suitable internal power source, such as a battery, capacitive power source or similar type of charge-storage device, etc., and/or can include one or more power conversion circuits suitable to convert external power into suitable power (e.g., conversion of externally-supplied AC power into DC power) for components of the machine 400. Power source 432 can also include some implementation of surge protection circuitry to protect the components of machine 400 from power surges.

As indicated above, machine 400 can include one or more interlinks or buses 434 operable to transmit communications between the various hardware components of the machine. A system bus 434 can be any of several types of commercially available bus structures or bus architectures.

Although various example components of an example machine 400 are described and illustrated, not all components are required in each machine or device described herein and no machine or device described herein is limited to including just the example components described and illustrated herein. For example, any of the various devices described herein, such as control panel 108, host server 112, credential device 116, and/or a UWB-enabled device according to the present disclosure, may comprise a different set and/or combination of the example components described and illustrated herein.

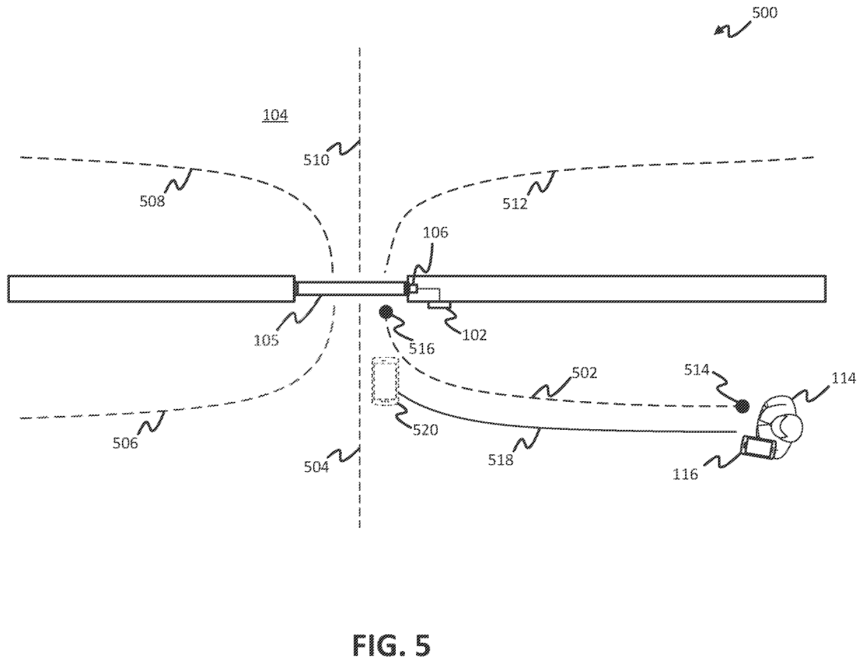

For ease of explanation, FIG. 5 illustrates a larger view 500 of example environment 100, with some elements removed for better illustration. Environment 500 includes reader 102, secure asset 104 secured by access point 105, and control mechanism 106. In some examples, secure asset 104 and access point 105 may be the same. A user 114 (or device) within or entering environment 500 may hold or carry a device, such as credential device 116 or other portable device, having one or more UWB sensors. While described herein primarily with reference to a “credential” device, it is understood that, in some examples, user 114 (or device) may hold or carry any UWB-enabled device, that is the same or different than the credential device, for use in the methods and systems for determining the position and/or intent of a user (or device) holding, carrying, wearing, or mounted with a UWB-enabled device described herein. Also illustrated in FIG. 5 are one or more distinct reference approaches or paths 502, 504, 506, 508, 510, 512 to access point 105. An approach or path may comprise a path of any suitable distance preceding, and in some cases immediately preceding, access point 105. Reference approaches/paths 502, 504, 506, 508, 510, 512 are provided only as examples for purposes of explanation, and any environment, such as environment 500, may include more or less or different reference approaches/paths than those illustrated.

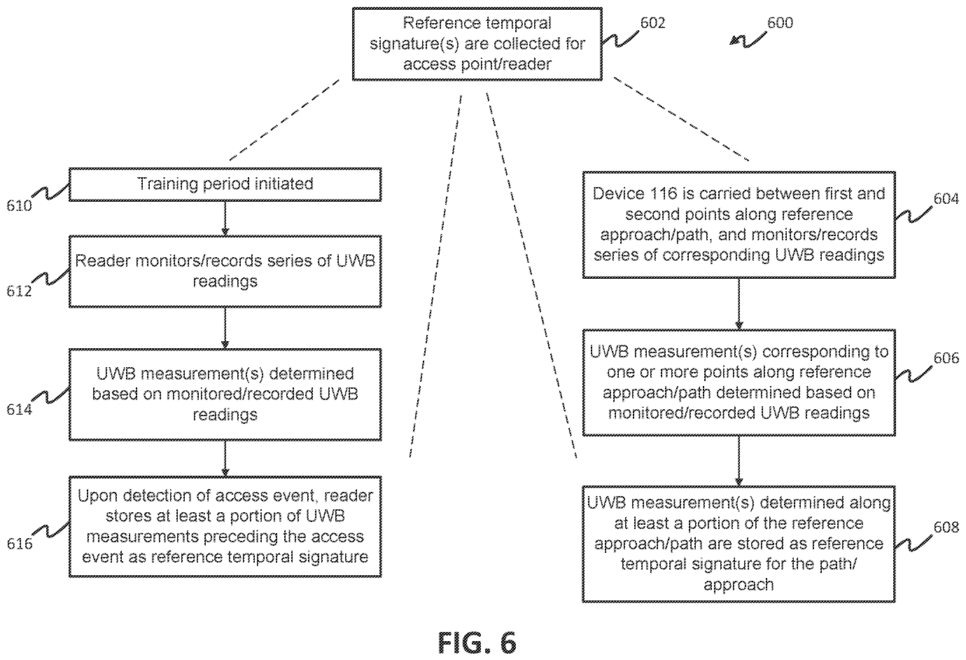

FIG. 6 is a flowchart generally illustrating example methods for a step 602 of collecting one or more reference temporal signatures associated with access point 105 and/or reader 102 within an environment, such as example environments 100, 500, based on one or more reference approaches/paths 502, 504, 506, 508, 510, 512, or portion(s) thereof for subsequent use in the methods of determining the position and/or intent of a user (e.g., intent to access the access point 105), as further described in detail herein. Collecting one or more reference temporal signatures associated with access point 105 and/or reader 102 may also be referred to as calibrating the access point 105 and/or reader 102.

In an example of collecting one or more reference temporal signatures, which may be referred to as a guided collection of reference temporal signatures, in step 604, for each of one or more of the reference approaches/paths 502, 504, 506, 508, 510, 512, device 116 is carried between a determined first point (e.g., a starting point) of the reference approach/path, such as point 514 of approach/path 502, to a determined second point (e.g., an end point) of the reference approach/path, such as point 516 of approach/path 502. In some examples, device 116 may alternatively or additionally be carried between the determined second point of the reference approach/path to the determined first point of the reference approach/path. In some examples, the first point may be a point along a reference approach/path that is farthest away from access point 105 and/or reader 102, and the second point may be a point along the reference approach/path that is nearest the access point and/or reader. Alternatively, the first point may be a point along a reference approach/path that is nearest the access point 105 and/or reader 102, and the second point may be a point along the reference approach/path that is farthest away from the access point and/or reader.

While device 116 is carried, such as by user 114, between the first and second points and/or between the second and first points of a given reference approach/path, such as between the first 514 and second 516 points of approach/path 502, the device can monitor and/or record a temporal series of one or more UWB readings or signals transmitted to or from reader 102 or between the device and the reader corresponding to the reference approach/path. The UWB readings or signals may be monitored and/or recorded at any suitable interval, such as: substantially continuously; periodically; randomly; or according to any other repeating or non-repeating pattern or algorithm.

In step 606, one or more UWB measurements, or calculations, corresponding to one or more points along the reference approach/path, such as reference approach/path 502, may be determined based on the monitored and/or recorded UWB readings or signals. The one or more UWB measurements corresponding to any given interval point along the reference approach/path may include any type of measurement based on UWB readings or signals, such as but not limited to, a radial distance (D), angle of arrival (AoA), signal-to-noise ratio (SNR), and/or line-of-sight (LoS) measurement. In an example, the UWB measurement corresponding to any given interval point along the reference approach/path may include just a single type of UWB measurement, such as one of a radial distance (D), angle of arrival (AoA), signal-to-noise ratio (SNR), or line-of-sight (LoS) measurement, while in other examples, the UWB measurements corresponding to any given interval point along the reference approach/path may include two or more types of UWB measurements, such as two or more of a radial distance (D), angle of arrival (AoA), signal-to-noise ratio (SNR), or line-of-sight (LoS) measurement. In a particular example, the UWB measurements corresponding to any given interval point along the reference approach/path include a radial distance (D) and angle of arrival (AoA) pair or other mathematical combination thereof. In some examples, the UWB measurements corresponding to the given point interval along the reference approach/path additionally include or mathematically combine an SNR and/or LoS measurement. The UWB measurements may be determined for points along the reference approach/path in any suitable interval, such as: substantially continuously; periodically; randomly; or according to any other repeating or non-repeating pattern or algorithm. The UWB measurements need not be determined for, or based on, all the UWB readings or signals monitored and/or recorded in step 604, but could be determined for, or based on, a subset of the UWB readings or signals.

In step 608, the one or more UWB measurements determined along at least a portion of the reference approach/path, such as reference approach/path 502, may be stored as a reference temporal signature for such reference approach/path. In some examples, where the UWB measurements determined at each interval point along the reference approach/path comprise two or more UWB measurements, such as a radial distance (D) and angle of arrival (AoA), the two or more UWB measurements for each interval point can be concatenated or combined in any manner, such as using any ordering algorithm or mathematical combination. A set of such concatenated or combined UWB measurements for at least a portion of the one or more interval points along the reference approach/path may be stored as the reference temporal signature for the reference approach/path. In some examples, the one or more UWB measurements determined along at least a portion of the reference approach/path, such as reference approach/path 502, may be further processed pursuant to any suitable algorithm or method and the output may be alternatively or additionally stored as the reference temporal signature for such reference approach/path. In still further examples, a reference temporal signature may include or be combined, in any suitable manner, with a “reference path signature” or any information used to determine a “reference path signature” or upon which a “reference path signature” is based as described in PCT International Pat. Appl. No. PCT/US2021/071497, titled “Location Recognition Using Inertial Measurement Unit,” filed Sep. 17, 2021, which is hereby incorporated by reference herein in its entirety. For example, readings or signals from an inertial measurement unit (IMU), such as from an accelerometer, gyroscope, and/or magnetometer, or information based on such signals or readings, can be concatenated or combined, using any ordering algorithm or mathematical combination, with the one or more UWB measurements to serve as a reference temporal signature and/or to provide additional speed and/or orientation information, which may also be used for determining intent.

In some examples, collecting reference temporal signatures for one or more reference approaches/paths (e.g., 502, 504, 506, 508, 510, 512) to an access point 105 and/or reader 102 may be collectively completed by a plurality of users 114 and/or using a plurality of devices 116. Likewise, collecting reference temporal signatures for one or more reference approaches/paths to each of a plurality of access points and/or readers within a given environment may be collectively completed by a plurality of users 114 and/or using a plurality of devices 116. Each reference temporal signature may be stored with an identifier and a label associating the reference temporal signature with the given access point 105 and/or reader 102. A reference temporal signature may also be stored with any other suitable information. For example, a reference temporal signature may also be stored with data indicating whether the reference temporal signature relates to a reference approach/path that is on the secure side or unsecure side of access point 105 and/or reader 102.

In some examples, software or an application (or “app”) executing on the device 116 or other UWB-enabled device can guide the user 114 through the calibration of environment 500 (i.e., through the collection of reference temporal signatures). For example, such app may guide the user 114 to traverse a typical path starting near the access point 105 and/or reader 102, moving away from the access point/reader (on the secure or unsecure side), and then return to the access point/reader. The speed at which the user 114 moves and/or the distance traversed by the user can be monitored, for example by device 116, and appropriate prompts, if desired, can be provided to the user through, such as but not limited to, prompts instructing the user to go slower/faster, go farther away from the reader, return to the reader, etc. Speed information for the user could be, but need not be based, on UWB readings or signals but, for example, could be based additionally or alternatively on readings or signals from one or more IMU sensors on device 116 (or other UWB enabled device), such as an accelerometer and/or gyroscope. Such guided process can be repeated for several paths, such as the most common paths, for both the secure and unsecure side of the access point 105 and/or reader 102.

Steps 604 through 608 of the example method of FIG. 6 may be carried out by and/or are described as being carried out by device 116. However, in other examples, some of the steps or portions of some or all of the steps 604 through 608 of the example method of FIG. 6 may be carried out by reader 102 or a combination of device 116 and reader 102. For example, and not limited by such example, steps 606 and 608 may instead be carried out by reader 102 or a combination of device 116 and reader 102. Also for example, the reference temporal signatures may instead be stored at reader 102 or both of, or a combination of, device 116 and reader 102. In still further examples, some of the steps or portions of the steps 604 through 608 may be carried out by, and/or reference temporal signatures may be stored at, control panel 108 and/or host server 112.

In another example, collecting one or more reference temporal signatures may be performed during a training or learning period, and may be referred to as a trained or learned collection of reference temporal signatures. For example, in step 610, a training period for reader 102 may be initiated. In an example, during the training period, reader could be in a UWB listen-only mode, in which access control decisions for access point 105 are not based on UWB position sensing signals and UWB signals are used solely or primarily for calibrating the access point and/or reader. The training period may be initiated, for example, upon installation or activation of reader 102. However, the training period may be initiated at any suitable time, such as but not limited to, upon an update of reader 102, pursuant to instructions received at the reader to start the training period, etc. In examples, the training period may be of predetermined length of time, such as but not limited to, a number of hours, a number of days, a number of weeks, etc. In some examples, the training period may extend indefinitely or until an end triggering event occurs. End triggering events may include but are not limited to: reader 102 receiving instructions to end the training period; reaching a certain or predetermined number of reference temporal signatures; reaching a reader limitation, such as a certain memory capacity; etc. During the training period, users can use one or more traditional methods for accessing (e.g., passing through) access point 105, such as but not limited to, entering credential data (e.g., PIN, biometric data, etc.) using a keypad or other interface of reader 102 and/or manually activating the access point using a credential device 116, such as through an app on the credential device. Once a training period is ended, reader 102 may switch to a normal operating mode, in which, in addition to or as an alternative to traditional methods for accessing access point 105, the various methods of determining the position and/or intent of a user (or device) based on UWB readings or signals transmitted by, received by, or communicated with a UWB-enabled device held, carried, or worn by, or mounted on, the user (or device), as described herein, may be used.

In step 612, during the training period, while device 116 is carried, such as by user 114, throughout environment 100, 500 and within UWB range of reader 102, the reader may monitor or record temporal UWB readings or signals transmitted to or from reader 102 or between device 116 and the reader. The UWB readings or signals may be monitored and/or recorded at any suitable interval, such as: substantially continuously; periodically; randomly; or according to any other repeating or non-repeating pattern or algorithm.

In step 614, one or more UWB measurements, or calculations, may be determined based on the monitored and/or recorded UWB readings or signals. As indicated previously, the one or more UWB measurements may include any type of measurement based on UWB readings or signals, such as but not limited to, a radial distance (D), angle of arrival (AoA), signal-to-noise ratio (SNR), and/or line-of-sight (LoS) measurement. In an example, the UWB measurement may include just a single type of UWB measurement, such as one of a radial distance (D), angle of arrival (AoA), signal-to-noise ratio (SNR), or line-of-sight (LoS) measurement, while in other examples, the UWB measurements may include two or more types of UWB measurements, such as two or more of a radial distance (D), angle of arrival (AoA), signal-to-noise ratio (SNR), or line-of-sight (LoS) measurement. In a particular example, the UWB measurements include a radial distance (D) and angle of arrival (AoA) pair or other mathematical combination thereof. In some examples, the UWB measurements additionally include or mathematically combine an SNR and/or LoS measurement. The UWB measurements may be determined at any suitable interval of UWB readings or signals, such as: substantially continuously; periodically; randomly; or according to any other repeating or non-repeating pattern or algorithm. The UWB measurements need not be determined for, or based on, all the UWB readings or signals monitored and/or recorded in step 612, but could be determined for, or based on, a subset of the UWB readings or signals.

In step 616, upon detection of an access event for access point 105 (e.g., access through the access point), such as access based upon on one or more traditional access methods, reader 102 may store at least a portion of the one or more UWB measurements preceding the access event as a reference temporal signature corresponding to the access point and/or the reader. Any portion or sub-portion of the one or more UWB measurements preceding the access event may be stored as the reference temporal signature, and it is not required that all consecutive UWB measurements corresponding to such portion or sub-portion are included as part of the stored reference temporal signature. As indicated above, in some examples, where the UWB measurements determined at each interval comprise two or more UWB measurements, such as a radial distance (D) and angle of arrival (AoA), the two or more UWB measurements at each interval can be concatenated or combined in any manner, such as using any ordering algorithm or mathematical combination. A set of such concatenated or combined UWB measurements for at least a portion of the intervals may be stored as the reference temporal signature. In some examples, at least a portion of the one or more UWB measurements preceding the access event may be further processed pursuant to any suitable algorithm or method and the output may be alternatively or additionally stored as the reference temporal signature. In still further examples, as indicated above, a reference temporal signature may include or be combined, in any suitable manner, with a “reference path signature” or any information used to determine a “reference path signature” or upon which a “reference path signature” is based as described in PCT International Pat. Appl. No. PCT/US2021/071497, titled “Location Recognition Using Inertial Measurement Unit,” which was previously incorporated by reference. For example, readings or signals from an IMU, such as from an accelerometer, gyroscope, and/or magnetometer, or information based on such signals or readings, can be concatenated or combined, using any ordering algorithm or mathematical combination, with the one or more UWB measurements to serve as a reference temporal signature and/or to provide additional speed and/or orientation information, which may also be used for determining intent. Step 616 may be repeated or performed for a plurality of access events, or in some examples each access event, during the training period thereby collecting a plurality of reference temporal signatures.

Similar to the guided collection of reference temporal signatures, in a trained or learned collection of reference temporal signatures, collecting reference temporal signatures for an access point 105 and/or reader 102 may be collectively completed by a plurality of users 114 and/or using a plurality of devices 116. Likewise, collecting reference temporal signatures for each of a plurality of access points and/or readers within a given environment may be collectively completed by a plurality of users 114 and/or using a plurality of devices 116. Each reference temporal signature may be stored with an identifier and a label associating the reference temporal signature with the given access point 105 and/or reader 102. A reference temporal signature may also be stored with any other suitable information. For example, a reference temporal signature may also be stored with data indicating whether the reference temporal signature relates to a reference approach/path that is on the secure side or unsecure side of access point 105 and/or reader 102. Classifying the reference temporal signature as on the secure side or unsecure side of access point 105 and/or reader 102 may be determined at least in part from the type of access event. For example, an access event requiring credential authentication (e.g., entering) may indicate that the reference temporal signature is on the unsecure side of access point 105 and/or reader 102, whereas an access event that does not involve credential authentication (e.g., exiting) may indicate that the reference temporal signature is on the secure side of the access point and/or the reader.

In some examples, steps 614 and 616 or portions thereof may be performed substantially simultaneously, or at least some portions of step 616 may be performed prior to step 614. For example, an access event for access point 105 may be detected prior to determining one or more UWB measurements based on the monitored and/or recorded UWB readings or signals. Waiting until detection of an access event prior to determining any UWB measurements based on the monitored and/or recorded UWB readings or signals can save processing power of, for example, reader 102 by deferring the determination of any UWB measurements until such UWB measurements are actually desired or needed.

Steps 610 through 616 of the example method of FIG. 6 may be carried out by and/or are described as being carried out by reader 102. However, in other examples, some of the steps or portions of some or all of the steps 610 through 616 of the example method of FIG. 6 may be carried out by device 116 or a combination of reader 102 and device 116. For example, and not limited by such example, steps 612 and 614 may instead be carried out by device 116 or a combination of reader 102 and device 116. Also for example, the reference temporal signatures may instead be stored at device 116 or both of, or a combination of, reader 102 and device 116. In still further examples, some of the steps or portions of the steps 610 through 616 may be carried out by, and/or reference temporal signatures may be stored at, control panel 108 and/or host server 112.

In a further example of collecting one or more reference temporal signatures, which is similar to the trained collection of reference temporal signatures, a reference temporal signature may be collected at generally any time following installation of reader 102 and may be added as an additional reference temporal signature, or may replace a previously stored reference temporal signature, corresponding to access point 105 and/or the reader. Such a method may be referred to as an on-the-fly collection of reference temporal signatures. Such on-the-fly method may include steps similar to steps 612 and 614. However, such steps need not be performed during a training period as described above. Rather, pursuant to an on-the-fly collection of reference temporal signatures, steps 612 and 614 may occur at any time. The on-the-fly collection of reference temporal signatures may also include a step similar to step 616. Specifically, upon detection of an access event for access point 105 (e.g., access through the access point), reader 102 may store at least a portion of the one or more UWB measurements preceding the access event as a reference temporal signature corresponding to the access point and/or the reader. As indicated above, the reference temporal signature may be stored as an additional reference temporal signature corresponding to access point 105 and/or reader 102 or may replace a previously stored reference temporal signature corresponding to the access point and/or the reader. As described with respect to step 616, any portion or sub-portion of the one or more UWB measurements preceding the access event may be stored as the reference temporal signature, and it is not required that all consecutive UWB measurements corresponding to such portion or sub-portion are included as part of the stored reference temporal signature. In some examples, where the UWB measurements determined at each interval comprise two or more UWB measurements, such as a radial distance (D) and angle of arrival (AoA), the two or more UWB measurements at each interval can be concatenated or combined in any manner, such as using any ordering algorithm or mathematical combination. A set of such concatenated or combined UWB measurements for at least a portion of the intervals may be stored as the reference temporal signature. In some examples, at least a portion of the one or more UWB measurements preceding the access event may be further processed pursuant to any suitable algorithm or method and the output may be alternatively or additionally stored as the reference temporal signature. Again, in some examples, a reference temporal signature may further include or be combined, in any suitable manner, with a “reference path signature” or any information used to determine a “reference path signature” or upon which a “reference path signature” is based as described in PCT International Pat. Appl. No. PCT/US2021/071497. Each reference temporal signature may be stored with an identifier and a label associating the reference temporal signature with the given access point 105 and/or reader 102. As described previously, a reference temporal signature may also be stored with any other suitable information. For example, a reference temporal signature may also be stored with data indicating whether the reference temporal signature relates to a reference approach/path that is on the secure side or unsecure side of access point 105 and/or reader 102. As indicated above, classifying the reference temporal signature as on the secure side or unsecure side of access point 105 and/or reader 102 may be determined at least in part from the type of access event.

As one example, the on-the-fly collection of reference temporal signatures may be desirable where UWB-based position and/or intent detection for a particular user failed, and the user had to use a backup method of accessing the access point 105, such as such as but not limited to, entering credential data (e.g., PIN, biometric data, etc.) using a keypad or other interface of reader 102 and/or manually activating the access point using a credential device 116, such as through an app on the credential device. Access by the user thereafter may indicate that the approach/path just taken by the user to access point 105 is, indeed, representative of at least one approach/path that could be taken by the user to get to the access point and/or representative of the user's intent to access the access point.

Any of the example methods for collecting one or more reference temporal signatures associated with one or more access points and/or readers within an environment may be used alone or in combination with one another. That is, while any of the foregoing example methods for collecting one or more reference temporal signatures may be used by itself, the methods are not exclusive of each other and may be used in any combination to collecting reference temporal signatures within environment 100, 500. Moreover, although the flowchart of FIG. 6 illustrates example methods as comprising sequential steps or processes as having a particular order of operations, some or many of the steps or operations in the flowchart can be performed in parallel or concurrently, and the flowchart should be read in the context of the various example embodiments of the present disclosure. Likewise, the order of the method steps or process operations illustrated in FIG. 6 may be rearranged for some embodiments. Similarly, the methods illustrated in FIG. 6 could have additional steps or operations not included therein or fewer steps or operations than those shown.

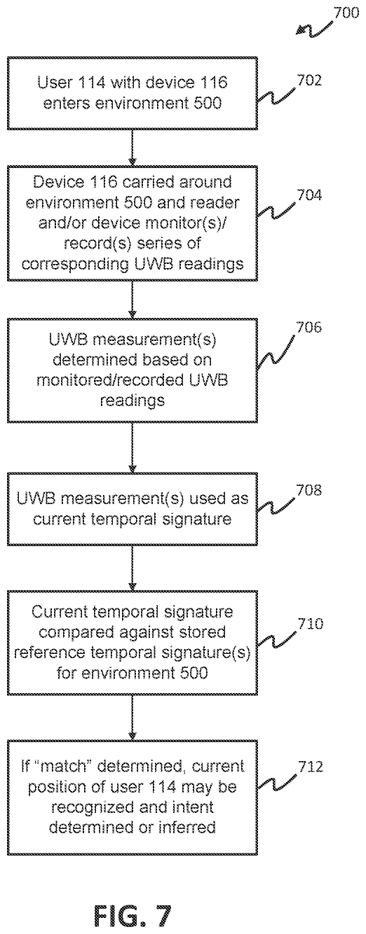

Once one or more reference temporal signatures for an environment 100, 500 are collected, the reference temporal signatures may be used to determine the position and/or intent of a user (or device), such as but not limited to, intent to access the access point 105, based on UWB readings or signals transmitted by, received by, or communicated with a UWB-enabled device held, carried, or worn by, or mounted on, the user (or device). FIG. 7 is a flowchart generally illustrating an example method 700 for determining the position and/or intent of a user (or device), with reference to the environment 500 of FIG. 5. In step 702, user 114 holding, carrying, or wearing UWB-enabled device 116 (or in an example where user 114 is a device, mounted with UWB-enabled device 116) enters environment 500. The user 114 and/or device 116 may be, but need not be, the same user(s) and/or device(s) used for calibrating the environment 500, as described above with respect to FIG. 6.

In step 704, while device 116 is carried, such as by user 114, throughout environment 500 and within UWB range of reader 102, the reader and/or device may monitor or record temporal UWB readings or signals transmitted to or from reader 102 or between the device and the reader. The UWB readings or signals may be monitored and/or recorded at any suitable interval, such as: substantially continuously; periodically; randomly; or according to any other repeating or non-repeating pattern or algorithm.

In step 706, one or more UWB measurements, or calculations, may be determined based on the monitored and/or recorded UWB readings or signals. As indicated previously, the one or more UWB measurements may include any type of measurement based on UWB readings or signals, such as but not limited to, a radial distance (D), angle of arrival (AoA), signal-to-noise ratio (SNR), and/or line-of-sight (LoS) measurement. In an example, the UWB measurement may include just a single type of UWB measurement, such as one of a radial distance (D), angle of arrival (AoA), signal-to-noise ratio (SNR), or line-of-sight (LoS) measurement, while in other examples, the UWB measurements may include two or more types of UWB measurements, such as two or more of a radial distance (D), angle of arrival (AoA), signal-to-noise ratio (SNR), or line-of-sight (LoS) measurement. In a particular example, the UWB measurements include a radial distance (D) and angle of arrival (AoA) pair or other mathematical combination thereof. In some examples, the UWB measurements additionally include or mathematically combine an SNR and/or LoS measurement. The UWB measurements may be determined at any suitable interval of UWB readings or signals, such as: substantially continuously; periodically; randomly; or according to any other repeating or non-repeating pattern or algorithm. The UWB measurements need not be determined for, or based on, all the UWB readings or signals monitored and/or recorded in step 704, but could be determined for, or based on, a subset of the UWB readings or signals.

In step 708, at any time, r, corresponding to the user's 114 current position, at least a portion of the UWB measurements preceding time/can be used as, or represent, a current temporal signature for the current approach or path 518 preceding the user's position at time/(e.g., the user's current position 520, represented by a device in phantom line). In an example, any portion or sub-portion of the UWB measurements preceding time t can be used as, or represent, the current temporal signature for user 114, and it is not required that all consecutive UWB measurements corresponding to such portion or sub-portion are included as part of the current temporal signature. Similarly, multiple current temporal signatures for the approach/path 518 preceding the user's current position 520 may be determined or generated from differing portions or temporal periods of the UWB measurements preceding time t. As indicated above, in some examples, where the UWB measurements determined at each interval comprise two or more UWB measurements, such as a radial distance (D) and angle of arrival (AoA), the two or more UWB measurements at each interval can be concatenated or combined in any manner, such as using any ordering algorithm or mathematical combination. A set of such concatenated or combined UWB measurements for at least a portion of time preceding time/may be included as the current temporal signature. In some examples, at least a portion of the UWB measurements preceding time/may be further processed pursuant to any suitable algorithm or method and the output may alternatively or additionally be used as, or represent, the current temporal signature. Moreover, in some examples, a current temporal signature may further include or be combined, in any suitable manner, with a “current path signature” or any information used to determine a “current path signature” or upon which a “current path signature” is based as described in PCT International Pat. Appl. No. PCT/US2021/071497, titled “Location Recognition Using Inertial Measurement Unit,” which was previously incorporated by reference. For example, readings or signals from an IMU, such as from an accelerometer, gyroscope, and/or magnetometer, or information based on such signals or readings, can be concatenated or combined, using any ordering algorithm or mathematical combination, with the one or more UWB measurements to serve as a current temporal signature and/or to provide additional speed and/or orientation information, which may also be used for determining intent.

In step 710, a current temporal signature may be compared or analyzed against the stored reference temporal signature(s) for environment 500 to determine whether the current temporal signature substantially matches, substantially aligns, or corresponds to any reference temporal signature, or any portion of a reference temporal signature. In an example, a current temporal signature may be compared or analyzed against the stored reference temporal signature(s), or any portion(s) thereof, for environment 500 to determine if the current temporal signature matches or aligns with any reference temporal signature, or portion thereof, within a predefined or predetermined tolerance. Determining whether a current temporal signature substantially matches, substantially aligns, or corresponds to a reference temporal signature, or portion thereof, may be performed using any suitable method(s), algorithm(s), or combination thereof. For example, determining whether a current temporal signature substantially matches, substantially aligns, or corresponds to a reference temporal signature, or portion thereof, may be performed using one or more methods or algorithms such as: decision tree(s) or tree ensemble(s); neural network(s); support vector machine(s); logistic regression; Bayesian statistics or methods; k-nearest neighbors algorithm (k-NN); principle component analysis (PCA); Mahalanobis distance measure(s), either directly or, for example, following a decomposition, such as by PCA; dynamic time warping (DTW); etc.

For example, in some cases, a similarity metric between the current temporal signature and one or more stored reference temporal signatures corresponding to access point 105 and/or reader 102 may be calculated using methods such as, but not limited to, k-NN or PCA with or without Mahalanobis distance scaling. The similarity metric represents the similarity between the current temporal signature and the respective reference temporal signature. In some examples, one or more of the similarity metrics may be used to classify the current temporal signature. For example, one or more of the similarity metrics may be used to classify the current temporal signature as being on a secure side or unsecure side of access point 105. In additional or alternative examples, one or more of the similarity metrics may be used to classify the current temporal signature beyond just being on a secure side or unsecure side of access point 105. For example, a third class (e.g., “other”) may be used to classify cases where a user is in UWB range of the reader 102 but the user is stationary, pauses, turns around, or takes some other similar action that does not necessarily demonstrate intent of the user to pass through access point 105. In algorithms that calculate a similarity metric as described above, a case may be classified into such a third class (e.g., “other”), in one example, by applying a predefined threshold to the similarity metric. If the similarity metric doesn't meet the predefined threshold, the current temporal signature may be classified into the third class. In another example, a case may additionally or alternatively be classified into such a third class by applying one or more predefined thresholds to one or more UWB measurements, alone or in combination, or temporal patterns thereof, such as but not limited to, the changing temporal pattern of radial distance (D). In yet another example, a case may additionally or alternatively be classified into such a third class by using speed information generated from one or more IMU sensors, such as an accelerometer and/or gyroscope, which may be embedded in device 116.

As another example, in some cases, DTW may be applied to a current temporal signature and one or more stored reference temporal signatures. DTW can be implemented, for example, in the C family of programming languages or other common programming languages. DTW should generally be fast enough for at least a relatively small number of reference temporal signatures with a relatively small number of points per signature. Furthermore, DTW accommodates multidimensional data, which facilitates use of different types of UWB signals in the signature (e.g., D, AoA, SNR, LOS, etc.), as described above. Additionally, DTW is robust to different numbers and temporal positions of sample points. This is desirable because a UWB receiver may generally sample at a fixed rate (e.g., 5 Hz), but the user 114 (carrying UWB-enabled device 116) may approach and/or depart from access point 105 and/or reader 102 at different speeds. Moreover, in some situations, the distance that a UWB receiver/transceiver (e.g., reader 102) starts sensing the UWB transmitter/transceiver (e.g., device 116) varies from time to time due to power fluctuations, RF attenuation effects, electronic timing variations, and/or a variety of other effects. As such, there is a possibility, if not probability, that sample points of the current temporal signature will not be exactly aligned with all of the sample points in any of the stored reference temporal signatures. Although DTW is robust to the number and alignment of sample points of the temporal signatures being compared, DTW generally assumes that at least the start and end points of the temporal signatures being compared are aligned. Accordingly, in some examples, the current temporal signature and a stored reference temporal signature may be pre-aligned. The current temporal signature and stored reference temporal signature may be pre-aligned, for example, using the UWB radial distance (D) measurement and/or other relatively reliable UWB outputs or measurements. For example, the current temporal signature and each stored reference temporal signature to which the current temporal signature is to be compared may be trimmed to approximately the same start and end points based on a radial distance (D) measurement determined for each of the start and end points. The trimmed current and reference temporal signatures can then be used in DTW to generate similarity metrics, which may then be used to determine the user's position and/or intent, as described herein.

In some examples, in which a reference temporal signature includes or is combined with a “reference path signature” or any information used to determine a “reference path signature” or upon which a “reference path signature” is based and in which a current temporal signature similarly includes or is combined with a “current path signature” or any information used to determine a “current path signature” or upon which a “current path signature” is based, as described in PCT International Pat. Appl. No. PCT/US2021/071497, any suitable method(s), algorithm(s), or combination thereof may be used to compare such “current path signature” information against such “reference path signature” information, as also described in PCT International Pat. Appl. No. PCT/US2021/071497.

In step 712, if a “match” between a current temporal signature and a stored reference temporal signature for environment 500 is determined, the current position 520 of user 114 (holding or mounted with device 116) may be identified as being near the access point and/or on a secure or unsecure side of the access point. Additionally or alternatively, if a “match” between a current temporal signature and a stored reference temporal signature for environment 500 is determined, an intent of the user 114 to access the access point 105 may be determined or inferred. Such determined or inferred intent of the user 114 to access the access point 105 can be used, alone or in conjunction with other information, such as but not limited to credential authentication, to make access control decisions for the access point, including so called “seamless” access control decisions, in which the user generally does not need to take any positive action beyond moving toward the access point in order to be properly authenticated and provided access to the access point.

In some examples, various steps or combinations of steps in example method 700, may generally run continuously or substantially continuously, at predefined times, periodically, upon receiving, detecting, or identifying a triggering event, and/or randomly while user 114 holding or carrying (or mounted with) device 116 moves around environment 500. For example, the steps of comparing a current temporal signature to one or more reference temporal signatures, or portions thereof, (i.e., step 710) and determining whether there is a “match” (i.e., step 712) may generally be performed on a continuous or substantially continuous basis. For example, steps 710 and 712 (and/or any other steps of method 700) may be performed after obtaining each UWB reading or relatively short series of UWB readings, such as but not limited to, 1 second of readings, 2 seconds of readings, etc., so as to generally give the practical effect of occurring continuously or substantially continuously. As another example, steps 710 and 712 (and/or any other steps of method 700) may be performed periodically, such as but not limited to, every predefined number of seconds (e.g., 10 seconds, 20 seconds, etc.). In still another example, steps 710 and 712 (and/or any other steps of method 700) may be performed upon detecting a triggering event, such as a detecting a certain state of device 116, detecting a certain motion, or lack thereof, of device 116, receiving certain user input at device 116, or any other suitable detectable or identifiable triggering event. For example, if it is detected that device 116 has entered a predefined threshold distance from reader 102, such as but not limited to, within 10 feet, within 6 feet, within 2 feet, etc., method 700 may identify this as a triggering event and steps 710 and 712 (and/or any other steps of method 700) may be performed.

Although the flowchart of FIG. 7 illustrates an example method as comprising sequential steps or processes as having a particular order of operations, some or many of the steps or operations in the flowchart can be performed in parallel or concurrently, and the flowchart should be read in the context of the various example embodiments of the present disclosure. The order of the method steps or process operations illustrated in FIG. 7 may be rearranged for some embodiments. Similarly, the method illustrated in FIG. 7 could have additional steps or operations not included therein or fewer steps or operations than those shown. Additionally, many of the steps of the example method of FIG. 7 may be carried out by reader 102, device 116, or a combination of reader 102 and device 116. In still further examples, some of the steps or portions of the steps of the example method of FIG. 7 may be carried out by control panel 108 and/or host server 112.

### Additional Examples

Example 1 includes subject matter relating to a non-transitory computer readable medium comprising executable program code, that when executed by one or more processors, causes the one or more processors to: monitor ultra-wideband (UWB) signals between a first device and second device, wherein the first device is in a fixed location and the second device is portable; determine a reference temporal signature associated with the first device based on the UWB signals; and store the reference temporal signature in the computer readable medium; wherein the reference temporal signature is indicative of intent to access a secure asset associated with the first device.

In Example 2, the subject matter of Example 1 optionally includes wherein determining the reference temporal signature comprises determining a UWB measurement for each of a plurality of points along a path traversed by the second device based on the UWB signals.

In Example 3, the subject matter of Example 2 optionally includes wherein the UWB measurement comprises at least one of: a radial distance (D) measurement, angle of arrival (AoA) measurement, signal-to-noise ratio (SNR) measurement, or line-of-sight (LoS) measurement.

In Example 4, the subject matter of Example 2 or 3 optionally includes wherein the UWB measurement comprises a combination of at least two of: a radial distance (D) measurement, angle of arrival (AoA) measurement, signal-to-noise ratio (SNR) measurement, or line-of-sight (LoS) measurement.

In Example 5, the subject matter of any of Examples 2 to 4 optionally includes wherein the UWB measurements for the plurality of points along the path traversed by the second device are stored as the reference temporal signature.

In Example 6, the subject matter of Example 1 optionally includes wherein determining the reference temporal signature comprises determining a plurality of different types of UWB measurements for each of a plurality of points along a path traversed by the second device.

In Example 7, the subject matter of Example 6 optionally includes wherein the plurality of different types of UWB measurements comprises at least two of: a radial distance (D) measurement, angle of arrival (AoA) measurement, signal-to-noise ratio (SNR) measurement, or line-of-sight (LoS) measurement.

In Example 8, the subject matter of Example 6 or 7 optionally includes wherein a combination of the UWB measurements for the plurality of points along the path traversed by the second device are stored as the reference temporal signature.

In Example 9, the subject matter of any of Examples 2 to 8 optionally includes wherein monitoring UWB signals between the first and second devices comprises instructing a user of the second device, via the second device, to traverse the path.

In Example 10, the subject matter of any of Examples 2 to 8 optionally includes wherein the executable program code further causes the one or more processors to initiate a training period prior to monitoring the UWB signals between the first and second devices.

In Example 11, the subject matter of Example 10 optionally includes wherein determining a reference temporal signature associated with the first device is performed on detection of an access event corresponding to the secure asset during the training period.

In Example 12, the subject matter of any of Examples 2 to 11 optionally includes wherein the path leads at least one of to or from the secure asset.

Example 13 includes subject matter relating to a non-transitory computer readable medium comprising executable program code, that when executed by one or more processors, causes the one or more processors to: determine a current temporal signature for a first device moving within an environment; compare the current temporal signature with at least a portion of a stored reference temporal signature corresponding to a secure asset within the environment; and base an access control decision corresponding to the secure asset on whether it is determined that the current temporal signature corresponds to the at least a portion of the stored reference temporal signature.

In Example 14, the subject matter of Example 13 optionally includes wherein determining the current temporal signature for the first device comprises monitoring ultra-wideband (UWB) signals between the first device and a second device, wherein the second device is in a fixed location corresponding to the secure asset.

In Example 15, the subject matter of Example 14 optionally includes wherein determining the current temporal signature for the first device further comprises determining a UWB measurement for each of a plurality of points along a path traversed by the first device.

Example 16, the subject matter of Example 15 optionally includes wherein the UWB measurement comprises at least one of: a radial distance (D) measurement, angle of arrival (AoA) measurement, signal-to-noise ratio (SNR) measurement, or line-of-sight (LoS) measurement.

In Example 17, the subject matter of Example 15 or 16 optionally includes wherein the UWB measurement comprises a combination of at least two of: a radial distance (D) measurement, angle of arrival (AoA) measurement, signal-to-noise ratio (SNR) measurement, or line-of-sight (LoS) measurement.

In Example 18, the subject matter of any of Examples 15 to 17 optionally includes wherein the UWB measurements for the plurality of points along the path traversed by the first device are determined as the current temporal signature.

In Example 19, the subject matter of Example 14 optionally includes wherein determining the current temporal signature for the first device further comprises determining a plurality of different types of UWB measurements for each of a plurality of points along a path traversed by the first device.

In Example 20, the subject matter of Example 19 optionally includes wherein the plurality of different types of UWB measurements comprises at least two of: a radial distance (D) measurement, angle of arrival (AoA) measurement, signal-to-noise ratio (SNR) measurement, or line-of-sight (LoS) measurement.

In Example 21, the subject matter of Example 19 or 20 optionally includes wherein a combination of the UWB measurements for the plurality of points along the path traversed by the second device are determined as the current temporal signature.

In Example 22, the subject matter of any of Examples 13 to 21 optionally includes wherein determining whether the current path signature corresponds to the at least a portion of the stored reference temporal signature comprises determining whether the current temporal signature matches the at least a portion of the stored reference temporal signature within a predefined tolerance.

In Example 23, the subject matter of any of Examples 13 to 22 optionally includes wherein determining whether the current temporal signature corresponds to the at least a portion of the stored reference temporal signature comprises analyzing the current temporal signature and the at least a portion of the stored reference temporal signature using at least one of: a decision tree; a decision tree ensemble; a neural network; a support vector machine; logistic regression; Bayesian statistics or method; a k-nearest neighbors algorithm (k-NN); a principle component analysis (PCA); a Mahalanobis distance measure; or dynamic time warping (DTW).

Example 24 includes subject matter (such as a method) for calibrating an environment. The method comprises monitoring ultra-wideband (UWB) signals between a first device and second device, wherein the first device is in a fixed location and the second device is portable; determining a reference temporal signature associated with the first device based on the UWB signals; and storing the reference temporal signature in a computer readable storage medium; wherein the reference temporal signature is indicative of intent to access a secure asset associated with the first device.

Example 25 includes subject matter (such as a method) for determining a location of a device within an environment. The method comprises determining a current temporal signature for a first device moving within the environment; comparing the current temporal signature with at least a portion of a stored reference temporal signature corresponding to a secure asset within the environment; and basing an access control decision corresponding to the secure asset on whether it is determined that the current temporal signature corresponds to the at least a portion of the stored reference temporal signature.

### Additional Notes

The above detailed description includes references to the accompanying drawings, which form a part of the detailed description. The drawings show, by way of illustration, specific embodiments that can be practiced. These embodiments may also be referred to herein as “examples.” Such embodiments or examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein. That is, the above-described embodiments or examples or one or more aspects, features, or elements thereof can be used in combination with each other.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure or portions thereof may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. In the context of this disclosure, a computer readable medium may be any medium that can contain, store, communicate, or transport the program for use by or in connection with the systems disclosed herein. As indicated above, the computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or EEPROM), a compact disc read-only memory (CD-ROM), or other optical, magnetic, or solid state storage device. As noted above, computer-readable media includes, but is not to be confused with, computer-readable storage medium, which is intended to cover all physical, non-transitory, or similar embodiments of computer-readable media.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A method for calibrating an environment, the method comprising:
monitoring ultra-wideband (UWB) signals between a first device and second device, wherein the first device is in a fixed location and the second device is portable;
determining a reference temporal signature associated with the first device based on the UWB signals; and
storing the reference temporal signature in a computer readable storage medium;
wherein the reference temporal signature is indicative of intent to access a secure asset associated with the first device.

2. The method of claim 1, wherein determining the reference temporal signature comprises determining a UWB measurement for each of a plurality of points along a path traversed by the second device based on the UWB signals, wherein the UWB measurement comprises at least one of: a radial distance (D) measurement, angle of arrival (AoA) measurement, signal-to-noise ratio (SNR) measurement, or line-of-sight (LoS) measurement.

3. (canceled)

4. The method of claim 2, wherein the UWB measurement comprises a combination of at least two of: a radial distance (D) measurement, angle of arrival (AoA) measurement, signal-to-noise ratio (SNR) measurement, or line-of-sight (LoS) measurement.

5. The method of claim 2, wherein the UWB measurements for the plurality of points along the path traversed by the second device are stored as the reference temporal signature.

6. The method of claim 1, wherein determining the reference temporal signature comprises determining a plurality of different types of UWB measurements for each of a plurality of points along a path traversed by the second device.

7. The method of claim 6, wherein the plurality of different types of UWB measurements comprises at least two of: a radial distance (D) measurement, angle of arrival (AoA) measurement, signal-to-noise ratio (SNR) measurement, or line-of-sight (LoS) measurement.

8. The method of claim 6, wherein a combination of the UWB measurements for the plurality of points along the path traversed by the second device are stored as the reference temporal signature.

9. The method of claim 2, wherein monitoring UWB signals between the first and second devices comprises instructing a user of the second device, via the second device, to traverse the path.

10. The method of claim 2, further comprising initiating a training period prior to monitoring the UWB signals between the first and second devices, wherein determining a reference temporal signature associated with the first device is performed on detection of an access event corresponding to the secure asset during the training period.

11. (canceled)

12. The method of claim 2, wherein the path leads at least one of to or from the secure asset.

13. A method for determining intent of a user within an environment, the method comprising:
determining a current temporal signature for a first device moving within the environment;
comparing the current temporal signature with at least a portion of a stored reference temporal signature corresponding to a secure asset within the environment; and
basing an access control decision corresponding to the secure asset on whether it is determined that the current temporal signature corresponds to the at least a portion of the stored reference temporal signature.

14. The method of claim 13, wherein determining the current temporal signature for the first device comprises monitoring ultra-wideband (UWB) signals between the first device and a second device, wherein the second device is in a fixed location corresponding to the secure asset.

15. The method of claim 14, wherein determining the current temporal signature for the first device further comprises determining a UWB measurement for each of a plurality of points along a path traversed by the first device, wherein the UWB measurement comprises at least one of: a radial distance (D) measurement, angle of arrival (AoA) measurement, signal-to-noise ratio (SNR) measurement, or line-of-sight (LoS) measurement.

16. (canceled)

17. The method of claim 15, wherein the UWB measurement comprises a combination of at least two of: a radial distance (D) measurement, angle of arrival (AoA) measurement, signal-to-noise ratio (SNR) measurement, or line-of-sight (LoS) measurement.

18. The method of claim 15, wherein the UWB measurements for the plurality of points along the path traversed by the first device are determined as the current temporal signature.

19. The method of claim 14, wherein determining the current temporal signature for the first device further comprises determining a plurality of different types of UWB measurements for each of a plurality of points along a path traversed by the first device, wherein the plurality of different types of UWB measurements comprises at least two of: a radial distance (D) measurement, angle of arrival (AoA) measurement, signal-to-noise ratio (SNR) measurement, or line-of-sight (LoS) measurement.

20. (canceled)

21. The method of claim 19, wherein a combination of the UWB measurements for the plurality of points along the path traversed by the second device are determined as the current temporal signature.

22. The method of claim 13, wherein determining whether the current path signature corresponds to the at least a portion of the stored reference temporal signature comprises determining whether the current temporal signature matches the at least a portion of the stored reference temporal signature within a predefined tolerance.

23. (canceled)

24. A non-transitory computer readable medium comprising executable program code, that when executed by one or more processors, causes the one or more processors to:
monitor ultra-wideband (UWB) signals between a first device and second device, wherein the first device is in a fixed location and the second device is portable;
determine a reference temporal signature associated with the first device based on the UWB signals; and
store the reference temporal signature in the computer readable medium;
wherein the reference temporal signature is indicative of intent to access a secure asset associated with the first device.

25. A non-transitory computer readable medium comprising executable program code, that when executed by one or more processors, causes the one or more processors to:
determine a current temporal signature for a first device moving within an environment;
compare the current temporal signature with at least a portion of a stored reference temporal signature corresponding to a secure asset within the environment; and
base an access control decision corresponding to the secure asset on whether it is determined that the current temporal signature corresponds to the at least a portion of the stored reference temporal signature.
